(19) United States
(12) Patent Application Publication
(10) Pub. No.: US 2008/0252637 A1
(43) Pub. Date: Oct. 16, 2008

(54) VIRTUAL REALITY-BASED TELECONFERENCING

(76) Inventors: Philipp Christian Berndt, Berlin (DE); Burckhardt Ruben Joseph Jason Bonello, Berlin (DE); Matthias Welk, Berlin (DE); Marc Werner Fleischmann, Foster City, CA (US)

Correspondence Address: HUGH P. GORTLER, 23 ARRIVO DRIVE, MISSION VIEJO, CA, 92692, US

(21) Appl. No.: 11/735,463

(22) Filed: Apr. 14, 2007

(51) Int. Cl. G06T 15/00

(52) U.S. Cl. 345/419

(57) ABSTRACT

A virtual reality environment is applied to teleconferencing such that the environment is used to enter into a teleconference.

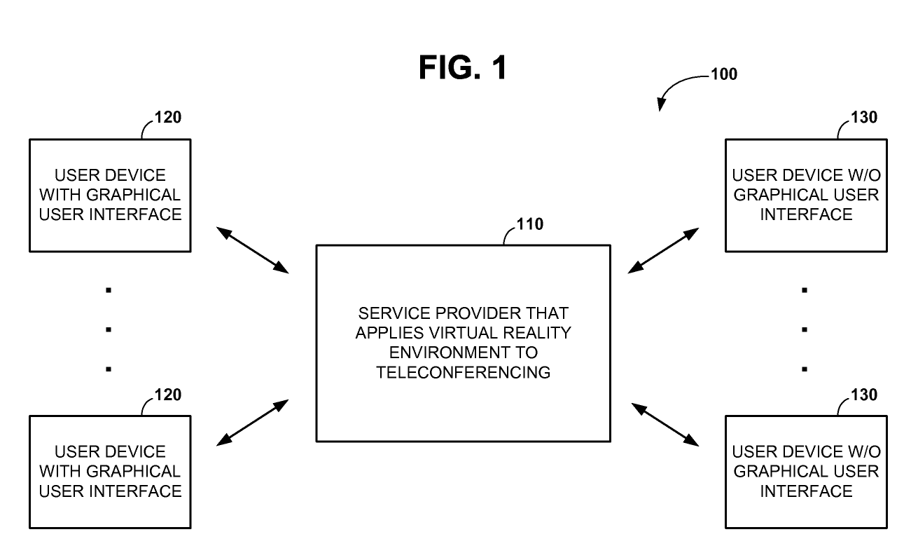

FIG. 1 is an illustration of a system in accordance with an embodiment of the present invention.

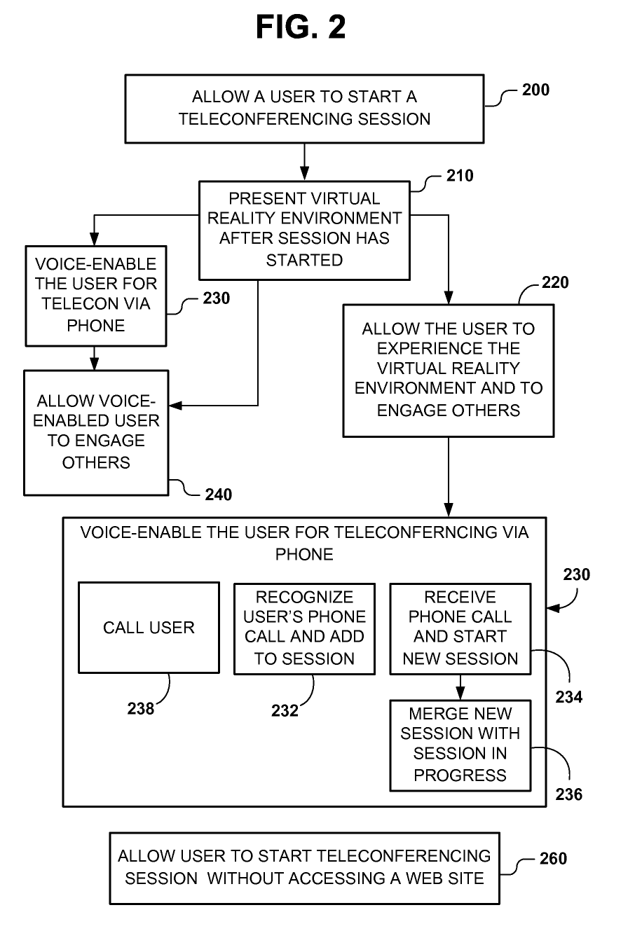

FIG. 2 is an illustration of a method in accordance with an embodiment of the present invention.

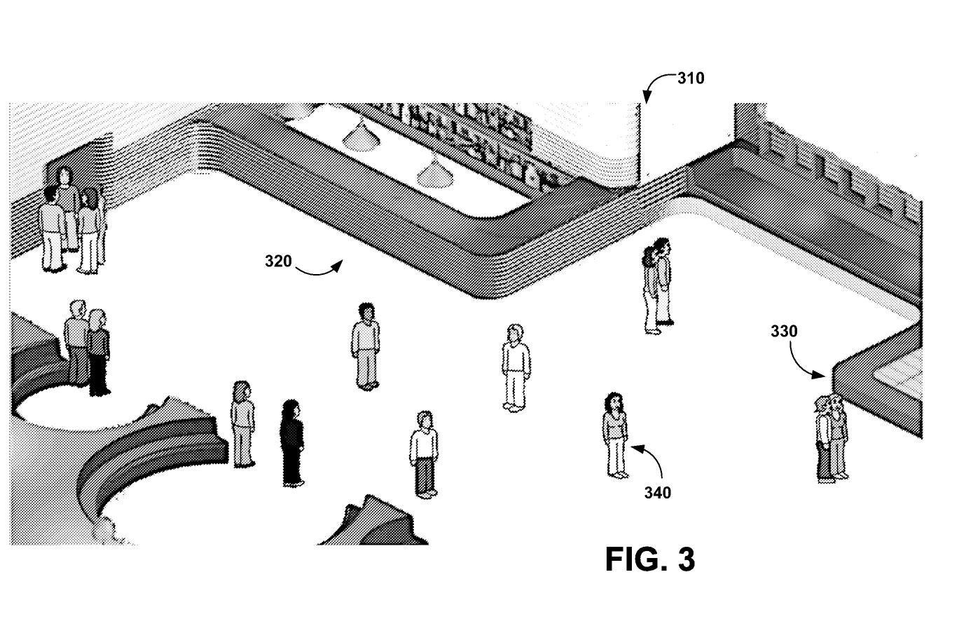

FIG. 3 is an illustration of a virtual reality environment in accordance with an embodiment of the present invention.

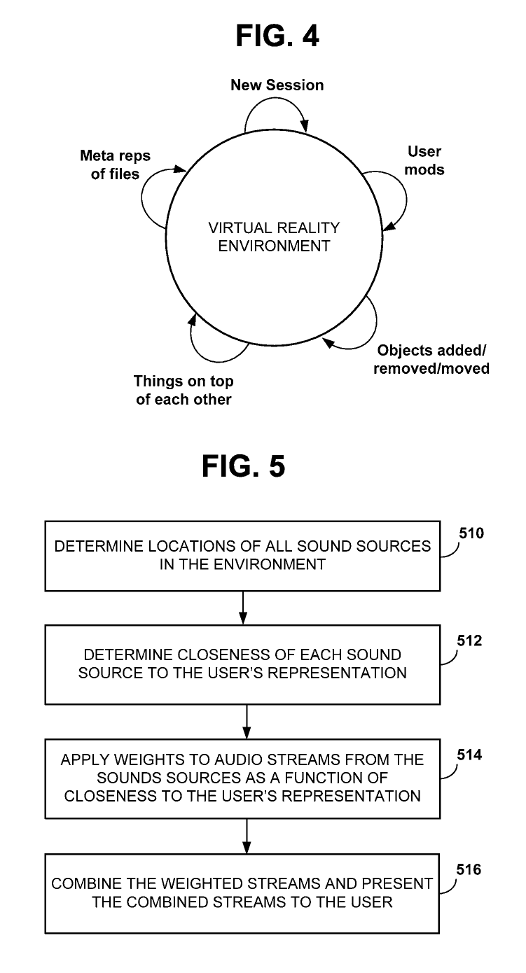

FIG. 4 is an illustration of a state diagram of a virtual reality environment.

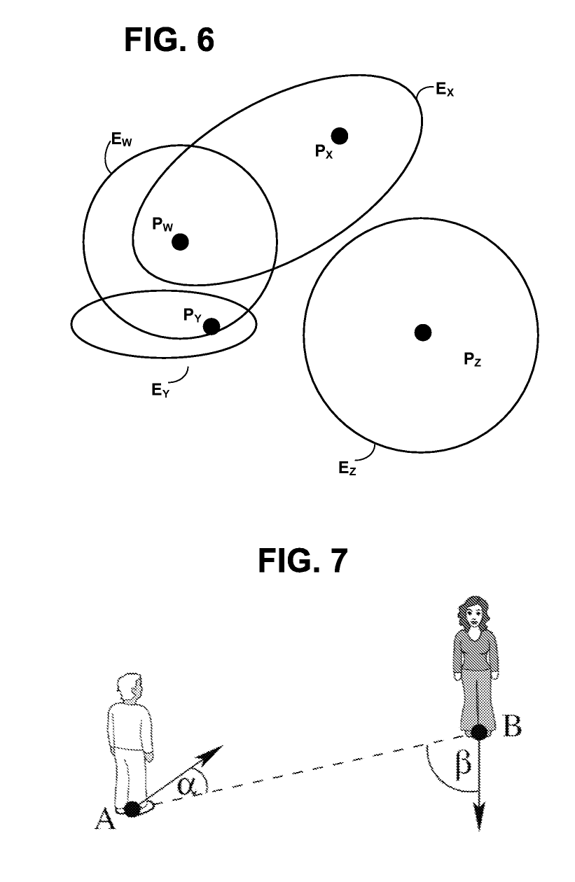

FIGS. 5 and 6 are illustrations of a method of supplying audio to a user in accordance with an embodiment of the present invention.

FIG. 7 is an illustration of two avatars facing each other.

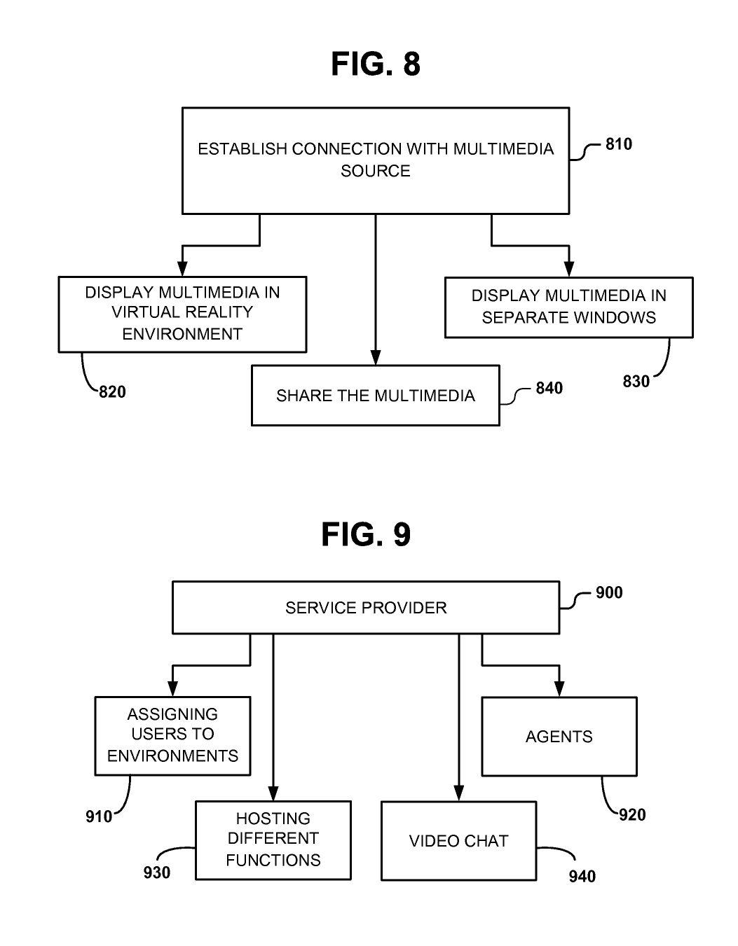

FIG. 8 is an illustration of a method in accordance with an embodiment of the present invention.

FIG. 9 is an illustration of services provided by a service provider in accordance with an embodiment of the present invention.

### DETAILED DESCRIPTION

Reference is made to FIG. 1, which illustrates a teleconferencing system 100 that includes a provider 110 of a teleconferencing service. The service provider 110 applies a virtual reality environment to teleconferencing such that the environment is used to enter into a teleconference. In some embodiments, the environment enables a user to enter the environment without knowing any others in the environment, yet enables the user to meet and hold a teleconference with others in the environment.

The term “user” refers to an entity that utilizes the teleconferencing service. The entity could be an individual, a group of people who are collectively represented as a single unit (e.g., a family, a corporation), etc.

The term “another” (when used alone) refers to another user. The term “others” refers to other users.

A user can connect to the service provider 110 with a user device 120 that has a graphical user interface. Such user devices 120 include, without limitation, computers, tablet PCs, VOIP phones, gaming consoles, televisions with set-top boxes, certain cell phones, and personal digital assistants. For instance, a computer can connect to the service provider 110 via the Internet or other network, and its user can enter into the virtual reality environment and take part in a teleconference.

A user can connect to the service provider 110 with a user device 130 that does not have a graphical user interface. Such user devices 130 include, without limitation, traditional telephones (e.g., touch tone phones, rotary phones), cell phones, VOIP phones, and other devices that have a telephone interface but no graphical user interface. For instance, a traditional phone can connect to the service provider 110 via a PSTN network, and its user can enter into the virtual reality environment and take part in a teleconference.

A user can utilize both devices 120 and 130 during a single teleconference. For instance, a user might use a device 120 such as a computer to enter and navigate the virtual reality environment, and a touch tone telephone 130 to take part in a teleconference.

Reference is now made to FIG. 2, which illustrates an example of how the virtual reality environment can be applied to teleconferencing. In this example, the service provider runs an on-line service that allows a user to start a teleconferencing session (block 200). In some embodiments, the service provider provides teleconferencing services via a web site. Using a web browser, the user enters the web site, and logs into the service, and the service provider starts a session.

After the session is started, a virtual reality environment is presented to the user (block 210). If, for example, the service provider runs a web site, a web browser can download and display a virtual reality environment to the user.

The virtual reality environment includes a scene and (optionally) sounds. A virtual reality environment is not limited to any particular type of scene or sounds. As a first example, a virtual reality environment includes a beach scene, with blue water, white sand and blue sky. In addition to this visualization, the virtual reality environment includes an audio representation of a beach (e.g. waves crashing against the shore, sea gulls cries). As a second example, a virtual reality environment provides a club scene, complete with bar, dance floor, and dance music (an exemplary bar scene 310 is depicted in FIG. 3).

A scene in a virtual reality environment is not limited to any particular number of dimensions. A scene could be depicted in two dimensions, three dimensions, or higher.

Included in the virtual reality environment are representations of the user and others. The representations could be images, avatars, live video, recorded sound samples, name tags, logos, user profiles, etc. In the case of avatars, live video or photos could be projected on them. The service provider assigns to each representation a location within a virtual reality environment. Each user has the ability to see and communicate with others in the virtual reality environment. In some embodiments, the user cannot see his own representation, but rather sees the virtual reality environment as his representation would see it (that is, from a first person perspective).

A user can control its representation to move around a virtual reality environment. By moving around a virtual reality environment, the user can experience the different sights and sounds that the virtual reality environment provides (block 220).

Additional reference is made to FIG. 3, which depicts a virtual reality environment including a club scene 310. The club scene 310 includes a bar 320, and dance floor 330. The user is represented by an avatar 340. Others in the club scene 310 are represented by other avatars. Dance music is projected from speakers (not shown) near the dance floor 330. As the user's avatar 340 approaches the dance floor 330, the music becomes louder. The music is loudest when the user's avatar 340 is in front of the speakers. As the user's avatar 340 is moved away from the speakers, the dance music becomes softer. If the user's avatar 340 is moved to the bar 320, the user hears background conversation (which might be actual conversations between others at the bar 320). The user might hear other background sounds at the bar 320, such as a bartender washing glasses or mixing drinks. Audio representation might involve changing the speaker's audio characteristics by applying filters (e.g. reverb, club acoustics).

The virtual reality environment just described is considered “immersive.” An “immersive” environment is defined herein as an environment with which a user can interact.

Reference is once again made to FIG. 2. A user can also move its representation around a virtual reality environment to engage others represented in the virtual reality environment (block 220). The user's representation may be moved by clicking on a location in the virtual reality environment, pressing a key on a keyboard, pressing a key on a telephone, entering text, entering a voice command, etc.

There are various ways in which the user can engage others in the virtual reality environment. One way is by wandering around the virtual reality environment and hearing conversations that are already in progress. As the user moves its representation around the virtual reality environment, that user can hear voices and other sounds.

Another way a user can engage others is by text messaging, video chat, etc. Another way is by clicking on another's representation, whereby a profile is displayed. The profile provides information about the person behind the representation. In some embodiments, images (e.g., profile photos, live webcam feeds) of others who are close by will automatically appear.

Still another way is to become voice-enabled via phone (block 230). Becoming voice-enabled allows the user to have teleconferences with others who are voice-enabled. For example, the user wants to have a teleconference using a phone. The phone could be a traditional phone or a VOIP phone. To enter into a teleconference, the user can call the service provider. When making the call by traditional telephone, the user can call a virtual reality environment (e.g., by calling a unique phone number, or by calling a general number and entering a user ID and PIN via DTMF, or by entering a code that the user can find on a web page).

When making the call by VOIP phone, the user can call the virtual reality environment by calling its unique SIP address. A user could be authenticated by appending credentials to the SIP address.

The service provider can join the phone call with the session in progress if it can recognize the user's phone number (block 232). If the service provider cannot recognize the user's phone number, the user starts a new session via the phone (block 234), and then the service provider merges the new phone session with the session already in progress (block 236).

Instead of the user calling the service provider, the user can request the service provider to call the user (block 238). For example, a sidebar includes a “CALL button” that the user clicks to become voice-enabled. Once voice-enabled, the user can walk up to another who is voice-enabled, and start talking immediately. A telephone icon over the head of an avatar could be used to indicate that its user is voice-enabled, and/or another graphical sign, such as sound waves, could be displayed near an avatar (e.g. in front of its face) to indicate that it is speaking or making other sounds.

In some embodiments, the user has the option of becoming voice-enabled immediately after starting a session (block 230). This option allows the user to immediately enter into teleconferences with others who are voice-enabled (block 240). A voice-enabled user could even call a person who has not yet entered the virtual reality environment, thereby pulling that person into the virtual reality environment (block 240). Once voice-enabled (block 230), the user remains voice-enabled until the user discontinues the call (e.g., hangs up the phone).

In some embodiments, a user can connect to the service provider with only a single device 120 (e.g., a computer with a microphone and speakers, a VOIP phone) that can navigate the virtual reality environment and also be used for teleconferences. For instance, a user connects to the web site via the Internet, is automatically voice-enabled, meets others in the virtual reality environment, and enters into teleconferences (indicated by the line that goes directly from block 210 to block 240).

VOIP offers certain advantages. VOIP on a broadband connection enables a truly seamless persistent connection that allows a user to “hang out” casually in one or more environments for a long time. Every now and then, something interesting might be heard, or someone's voice might be recognized, whereby the user can pay more attention and just walk over to chat. Yet another advantage of VOIP is that stereo sound connections can be easily established.

In some embodiments, the service provider runs a web site, but allows a user to log into the teleconferencing service and enter into a teleconference without accessing the web site (block 260). A user might only have access to a touch-tone telephone or other device 130 that can't access the web site or display the virtual reality environment. Or the user might have access to a single device that can either access the web site or make phone calls, but not both (e.g., a cell phone). Consider a traditional telephone. With only the telephone, the user can call a telephone number and connect to the service provider. The service provider can then create a representation of the user in virtual reality environment. Via telephone signals (e.g., DTMF, voice control), the user can move its representation around in the virtual reality environment, listen to other conversations, meet other people and experience the sounds (but not sights) of the virtual reality environment. Although the user cannot see its representation, others who access the web site can see the user's representation.

A teleconference is not limited to conversations between a user and another (e.g., a single person). A teleconference can involve many others (e.g., a group). Moreover, others can be added to a teleconference as they meet and engage those already in the teleconference. And once engaged in one teleconference, a person has the ability to “listen in” on other teleconferences, and seamlessly leave the one teleconference and join another teleconference. A user could even be involved in a chain of teleconferences (e.g., a line of people where person C hears B and D, and person D hears C and E, and so on).

If more than one virtual reality environment is available to a user, the user can move into and out of the different environments, and thereby meet even more different groups of people. Each of the virtual reality environments can be uniquely addressable via an Internet address or a unique phone number. The service provider can then place each user directly into the selected target virtual reality environment. Users can reserve and enter private virtual reality environments to hold private conversations. Users can also reserve and enter private areas of public environments to hold private conversations. A web browser or other graphical user interface could include a sidebar or other means for indicating different environments that are available to a user. The sidebar allows a user to move into and out of different virtual reality environments, and to reserve and enter private areas of a virtual reality environment.

A service provider can host multiple teleconferences in a virtual reality environment. A service provider can host multiple virtual reality environments simultaneously. A user can be in more than one virtual reality environment simultaneously.

Reference is now made to FIG. 4, which illustrates a state diagram of a virtual reality environment (directed arrows in the diagram indicate actions). The state of a virtual reality environment may be persistent in that it continues to exist throughout many user sessions and it continues to exists through the actions of different users. This allows a virtual reality environment to be modified by one user, and the modifications observed by others. For example, graffiti can be written on walls, a light switch in a virtual reality environment could be switched on and off, etc.

Objects in the virtual reality environment can be added, removed, and moved by users. Examples of objects include sound sources (e.g., music boxes, bubbling fish tanks), data objects (e.g., a modifiable book with text and pictures), visualized music objects, etc. Objects can have properties that allow a user to perform certain actions on them. A user could sit on a chair, open a window, operate a juke box. Objects could have profiles too. For example, a car in a virtual show room could have a make, model, year, top speed, number of cylinders, etc.

The persistent state also allows “things” to be put on top of each other. A file can be dropped onto a user or dropped onto the floor as a way of sharing the file with the user. A music or sound file could be dropped on a jukebox. A picture or video on a projector device to trigger playback/display. A multimedia sample (e.g., an audio clip or video clip containing a message) could be “pinned” to a whiteboard.

The persistent state also allows for meta-representations of files. These meta-representations may be icons that offer previews of an actual file. For example, an audio file might be depicted as a disk, an image file might depicted as a small picture (maybe in a frame), etc.

A virtual reality environment could overlap real space. For example, a scene of a real place is displayed (e.g., a map of a city or country, a room). Locations of people in that real place can be determined, for example with GPS phones. The participating people whose real locations are known are represented virtually by avatars in their respective locations in the virtual reality environment. Or, the place might be real, but the locations are not. Instead, a user's avatar wanders to different places to meet different people.

Different virtual reality environments could be linked together. Virtual reality environments could be linked to form a continuous open environment, or different virtual reality environments could be linked in the same way web pages are linked. There can be links from one virtual reality environment to another environment. There could be links from a virtual reality environment, object or avatar to the web, and vice versa. As examples, a link from a user's avatar could lead to a web version of that user's profile. A link from a web page or a unique phone number could lead to a user's favorite virtual reality environment or a jukebox play list.

Reference is now made to FIG. 5, which illustrates how a user experiences audio in a virtual reality environment. The user has a location in the environment and establishes an audio connection with that location.

At block 510, locations of all sound sources in the virtual reality environment are determined. Sound sources include objects in the virtual reality environment (e.g., a jukebox, speakers, a running stream of water), and representations of those users who are talking.

At block 512, closeness of each sound source to the user's representation is determined. The closeness is a function of a topology metric. In the virtual reality environment, the metric could be Euclidean distance between the user and the sound source. The distance may even be a real distance between the user and the source. For instance, the real distance might be the distance between a user in New York City and a sound source (e.g., another user) in Berlin.

At block 514, audio streams from the sound sources are weighted as a function of closeness to the user's representation. Sound sources closer to the user's representation would receive higher weights (sound louder) than sound sources farther from the user's representation.

At block 516, the weighted streams are combined and presented to the user. Sounds from all sources available to the user are processed (e.g. alienated, filtered, phase-shifted) and mixed together and supplied to the user. The sounds do not include the user's own voice. The audio range of the user and each sound source can have a geometric shape or a shape that simulates real life attenuation.

Additional reference is made to FIG. 6, which illustrates the use of an audio range to perform additional attenuation of sound in a virtual reality environment. A user's avatar is at location P_{W} and the avatars of three others are at locations P_{X}, P_{Y} and P_{Z}. In FIG. 6, the avatars are represented as points. Audio ranges of the avatars at locations P_{W} and P_{Z} are indicated by circles E_{W} and E_{Z}. Audio ranges of the avatars at locations P_{X} and P_{Y} are indicated by ellipses E_{X} and E_{Y}. The elliptical range indicates that the sound from these avatars is directional.

The audio range may be a receiving range or a broadcasting range. If a receiving range, a user will hear others within that range. Thus, the user will hear others whose avatars are at locations P_{X} and P_{Y}, since the audio ranges E_{X} and E_{Y} intersect the range E_{W}. The user will not hear the person whose avatar is at location P_{Z}, since the audio range E_{W} does not intersect the range E_{Z}.

If the audio range is a broadcasting range, a user hears those sources in whose broadcasting range he is. Thus, the user will hear the person whose avatar is at location P_{X}, since location P_{W} is within the ellipse E_{X}. The user will not hear the people whose avatars are at locations P_{Y} and P_{Z}, since the location P_{W} is outside of the ellipses E_{Y} and E_{Z}.

In some embodiments, the user's audio range is fixed. In other embodiments, the user's audio range can be dynamically adjusted. For instance, the audio range can be reduced if a virtual reality environment becomes too crowded. Some embodiments might have a function that allows for private conversations. This function may be realized by reducing the audio range (e.g. to a whisper) or by forming a disconnected “sound bubble.”

In some embodiments, metrics might be used in combination with the audio range. For example, a sound will fade as the distance between the source and the user increases, and the sound will be cut off as soon as the audio source is out of range.

In some embodiments, sounds from a user may be projected equally in all directions (that is, sound is omni-directional). In other embodiments, the sound projection may be directional or asymmetric.

User representations are not limited to avatars. However, avatars offer certain advantages. Avatars allow one user to meet another user through intuitive actions. All a user need do is control its avatar to walk up to another avatar and face it. The user can then introduce himself, and invite another to enter into a teleconference.

Another intuitive action is realized by controlling the gestures of the avatars. This can be done to convey information from one user to another. For instance, gestures can be controlled by pressing buttons on a keyboard or keypad. Different buttons might correspond to gestures such as waving, kissing, smiling, frowning etc. In some embodiments, the gestures of the user can be monitored via a webcam, corresponding control signals can be generated, and the control signals can be sent to the service provider. The service provider can then use those control signals to control the gesture of an avatar.

Yet another intuitive action is realized by the orientation of two avatars. For instance, the volume of sound between two users may be a function of relative orientation of the two avatars. Avatars facing each other will hear each other better than one avatar facing away from the other, and much better than two avatars facing in different directions.

Reference is made to FIG. 7, which shows two avatars A and B facing in the directions of the arrows. The avatars A and B are facing each other directly if angles α and β between the avatars' attitude and their connecting line AB equal zero. Assume avatar A is a speaker and avatar B is a listener. The value of the attenuation function can vary differently for changes to α and β. In this case the attenuation is asymmetrical. One advantage of orientation-based attenuation is allowing a user to take part in one conversation, while casually hearing other conversations.

The attenuation may also be a function of the distance between avatars A and B. The distance between avatars A and B may be taken along line AB.

Reference is now made to FIG. 8. Connections are not limited to audio sources. Connections can also be made with multimedia sources (block 810). Examples of such multimedia include, without limitation, video streams, text chat messages, instant messenger messages, avatar gestures or moves, mood expressions, emoticons, and web pages.

Multimedia sources could be displayed (e.g., viewed, listened to) from within a virtual reality environment (block 820). For example, a video clip could be viewed on a screen inside a virtual reality environment. Sound could be played from within a virtual reality environment.

Multimedia sources could be viewed in separate popup windows (block 830). For example, another instance of a web browser is opened, and a video clip is played in it.

The virtual reality environment facilitates sharing the multimedia (block 840). Multiple users can share a media presentation (e.g., view it, edit it, browse, listen to it), and, at the same time, discuss the presentation via teleconferencing. In some embodiments, one of the users can control the presentation of the multimedia. This feature allows all of the browsers to be synchronized, so all users can watch a presentation at the same time. In other embodiments, each user has control over the presentation, whereas the browsers are not synchronized.

A multimedia connection can be shared in a variety of ways. One user can share a media connection with another user by drag-and-dropping a multimedia representation onto the other user's avatar, or by causing its avatar to hand the multimedia representation to the other user user's avatar.

As a first example, a first user's avatar drops a video file photo or document on a second user's avatar. Both the first and second user then watch the video in a browser or media player, while discussing it via teleconferencing.

As a second example, a first user's avatar drops a URL on a second user's avatar. A web browser for each user opens, and downloads content at the URL. The first and second users can then co-browse, while discussing the content via teleconferencing.

As a third example, a user presents something to the surrounding avatars. All users within range get to see the presentation (first, however, they might be asked whether they want to see the presentation).

The multimedia connection provides another advantage: it allows telephones and other devices without browsers to access content on the Internet. For example, a multimedia connection could provide streaming audio to a virtual reality environment. The streaming audio would be an audio source that has a specific location in the virtual reality environment. A user with only a standard telephone can wander around the virtual reality environment and find the audio source. Consequently, the user can listen to the streaming audio over the telephone.

Reference is now made to FIG. 9. The service provider 900 could provide other services. One service is automatically assigning a user to certain virtual reality environments based on a characteristic of the user (block 910). The characteristic may be a parameter in the user's profile, or an interest of the user, or a mood of the user, or some other characteristic.

A user may have multiple profiles. Each profile represents a different aspect of the user. Different profiles give the user access to certain virtual reality environments. A user can switch between profiles during a session.

The profile can state a need. For example, a profile might reveal that the user is shopping for an automobile. The user could be automatically assigned to a virtual show room, including representations of automobiles, and representations of salesmen.

In some embodiments, user profiles can be made public, so they can be viewed by others. For instance, a first user can click on the avatar of a second user, and the profile of that second user appears as a form of introduction. Or, a first user might wander around a virtual reality environment, looking for people to meet. The first user could learn about a second user by clicking on the avatar of that second user. In response, the second user's profile would be displayed to the first user. If the profile does not disclose the user's real name and phone number, the second user stays anonymous.

Another service is providing agents (e.g. operators, security, experts) that offer services to those in the virtual reality environment (block 920). As a first example, users might converse while watching a movie, while an agent finds information about the cast. As a second example, a user chats with another person, and the person requests an agent to look up something with a search engine. As a third example, an agent identifies lonely participants that seem to match and introduces them to each other.

Another service is providing a video chat service (block 930). For instance, the service provider might receive web camera data from different users, and associate the web camera data with the different users such that a user's web camera data can be viewed by certain other users.

Yet another service is hosting different functions in different virtual reality environments (block 940). Examples of different functions include, without limitation, social networking, business conferencing, business-to-business services, business-to-customers services, trade fairs, conferences, work and recreation places, virtual stores, promoting gifts, on-line gambling and casinos, virtual game and entertainment shows, virtual schools and universities, on-line teaching, tutoring sessions, karaoke, pluggable (team) games, casinos, award-based contests, clubs, concerts, virtual galleries, museums, and demonstrations or any scenario available in real life. A virtual reality environment could be used to host a television show or movie.

The system is not limited to any particular architecture. For example, the system of FIG. 1 can be implemented as a client-server system. In such a system, the service provider includes one or more servers, and the different user devices are client devices. Certain types of client devices (e.g., computers) can connect to the servers via a network such as the Internet. Other types of client devices can connect via different networks. For instance a traditional telephone can connect via PSTN lines, VOIP phones can connect through the Internet, etc.

Teleconferencing according to the present invention can be performed conveniently. Entering into a teleconference can be as simple as going to a web site, and clicking a mouse button (maybe a few times). Phone numbers do not have to be reserved. Pre-conference introductions do not have to be made. Special hardware (e.g., web cameras, soundcards, and microphones) is not needed, since voice communication can be provided by a telephone. Communication is intuitive and, therefore, easy to learn. Audio-visual dynamic multi group communication is enabled. A user can move from one group to the other and thereby change whom they are communicating with.

A system according to the present invention allows for a convergence and integration of different communication technologies. Teleconferences can be held by users having traditional phones, VOIP phones, devices with GUI interfaces and Internet connectivity, etc.

1. A method comprising applying a virtual reality environment to teleconferencing such that the environment is used to enter into a teleconference.

2. The method of claim 1, wherein the environment allows a user to enter without knowing any other in the environment, yet enable the user to meet and hold a teleconference with at least one other.

3. The method of claim 1, wherein applying the virtual reality environment includes presenting the virtual reality environment to a user, presenting representations of the user and others in the virtual reality environment, and enabling the user's representation to experience the virtual reality environment, meet the others, and enter into teleconferences.

4. The method of claim 1, wherein the virtual reality environment enables a user to teleconference via a phone.

5. The method of claim 1, wherein the virtual reality environment enables a user to teleconference via a VOIP device.

6. The method of claim 1, wherein applying the environment includes starting a session with a user, presenting a virtual reality environment to the user, recognizing a phone call from the user, and adding the phone call to the session.

7. The method of claim 1, wherein applying the environment includes starting a first session with a user, presenting a virtual reality environment to the user, starting a second session in response to a phone call, and merging the first and second sessions if the phone call is made by the user.

8. The method of claim 1, further comprising calling the user at the user's request so the user can be voice-enabled in the virtual reality environment.

9. The method of claim 1, wherein when a user calls another not represented in the virtual reality environment, a representation of said another is added to the virtual reality environment.

10. The method of claim 1, wherein the virtual reality environment enables a user with only a device that can't display the virtual reality environment to enter into teleconferences and experiences sounds but not sights of the virtual reality environment.

11. The method of claim 1, wherein more than one virtual reality environment can be applied to the teleconferencing.

12. The method of claim 11, wherein a user can move into and out of different virtual reality environments.

13. The method of claim 11, wherein the virtual reality environments are linked.

14. The method of claim 11, wherein each of each virtual reality environment is uniquely addressable.

15. The method of claim 1, wherein at least some of the virtual reality environment is private.

16. The method of claim 1, wherein the virtual reality environment has a persistent state.

17. The method of claim 1, wherein the virtual reality environment overlaps a real space.

18. The method of claim 1, wherein a user establishes a connection with a location in the virtual reality environment.

19. The method of claim 1, wherein a user has an audio range in the virtual reality environment.

20. The method of claim 19, wherein the audio range is dynamically adjustable.

21. The method of claim 1, wherein audio between users is attenuated as a function of closeness between the users.

22. The method of claim 1, wherein a user is represented by an avatar in the virtual reality environment, and wherein the user can control its avatar to move around the virtual reality environment.

23. The method of claim 22, further comprising allowing a user to meet another through intuitive actions of the user's avatar.

24. The method of claim 22, further comprising accepting control inputs from the user to control gestures of the user's avatar.

25. The method of claim 1, wherein volume of sound between the user and another is a function of relative orientation of their representations in the virtual reality environment.

26. The method of claim 1, wherein a user establishes a connection with a location in the virtual reality environment, and wherein the connection is also established with a multimedia source.

27. The method of claim 26, wherein the user and others share a multimedia connection by each viewing a window that displays the multimedia and, at the same time, discussing the displayed multimedia via the teleconferencing.

28. The method of claim 26, wherein the user and another share the multimedia connection by co-browsing.

29. The method of claim 26, wherein a user shares a multimedia source with another by drag-and-dropping a multimedia representation proximate the other's representation.

30. The method of claim 1, further comprising mixing Internet content with phone links, whereby a user can access content on the Internet via a phone interface.

31. The method of claim 1, wherein additional virtual reality environments are available to a user, wherein the user is instead assigned to one of the additional environments based on a characteristic of the user.

32. The method of claim 1, wherein a user has multiple profiles, each profile representing a different aspect of the user, wherein the user can switch between multiple profiles.

33. The method of claim 1, wherein a user has a profile that can be made public.

34. The method of claim 33, wherein the user has an option of remaining anonymous.

35. The method of claim 1, further comprising providing service agents in the virtual reality environment.

36. Apparatus for applying a virtual reality environment to teleconferencing to enable a user to enter the virtual reality environment without knowing any other in the virtual reality environment, yet enable the user to meet and hold a teleconference with others in the virtual reality environment.

37. A system comprising:
means for teleconferencing; and
means for coupling an immersive virtual reality environment with the teleconferencing.

38. The system of claim 37, wherein the system is web-based.

39. A teleconferencing method, comprising:
entering a virtual reality environment provided by a service provider;
navigating an avatar around the virtual reality environment;
establishing a phone call with the service provider to become voice-enabled; and
talking to voice-enabled others who are represented in the virtual reality environment.
